(19) United States
(12) Patent Application Publication
(10) Pub. No.: US 2016/0332231 A1
(43) Pub. Date: Nov. 17, 2016

(54) ELECTRODE MATERIAL AND METHOD FOR PRODUCING ELECTRODE MATERIAL

(71) Applicant: MEIDENSHA CORPORATION, Tokyo (JP)

(72) Inventors: Keita ISHIKAWA, Nakano-ku, Tokyo (JP); Kaoru KITAKIZAKI, Saitama-shi, Saitama (JP); Shota HAYASHI, Edogawa-ku, Tokyo (JP)

(73) Assignee: MEIDENSHA CORPORATION, Tokyo (JP)

(21) Appl. No.: 15/112,358

(22) PCT Filed: Jan. 5, 2015
(86) PCT No.: PCT/JP2015/050056

§ 371 Date: Jul. 18, 2016

(30) Foreign Application Priority Data
Jan. 23, 2014 (JP) 2014-009952

(51) Int. Cl. B22F 3/16; H01H 11/04; C22C 9/00; B22F 9/04; B22F 1/00

(52) U.S. Cl. CPC B22F 3/16; B22F 9/04; B22F 1/0014; C22C 9/00; H01H 11/048; B22F 2301/10; B22F 2301/20; B22F 2304/10

(57) ABSTRACT

An electrode material obtained by press molding a mixed powder where a Cu powder, a Cr powder and a refractory metal powder (for example, a Mo powder) are mixed and then sintering the thus-obtained molded body in a non-oxidizing atmosphere at a temperature that is not higher than the melting point of Cu. As the Cr powder to be mixed in the mixed powder, a Cr powder wherein the volume-based relative particle amount of particles having particle diameters of 40 μm or less is less than 10% is used. The Cr powder is mixed in the mixed powder in an amount of 10-50% by weight, while the refractory metal powder is mixed in the mixed powder in an amount of 1-10% by weight.

### TECHNICAL FIELD

The present invention relates to an electrode material used for an electrode of a vacuum interrupter etc. and to a method for producing the electrode material.

### BACKGROUND OF THE INVENTION

A copper-molybdenum-chromium (hereinafter expressed as Cu—Mo—Cr) composite metal has been known as an electrode material for a vacuum interrupter excellent in electrical properties such as a current-interrupting capability and dielectric strength, in addition to being superior in welding resistance to conventionally known materials e.g. a copper-bismuth (Cu—Bi) composite metal, a copper-tungsten (Cu—W) composite metal and the like (for example, Patent Documents 1-3).

As a method for producing a high-quality and high-performance electrode material in use of the Cu—Mo—Cr composite metal, there has been proposed a sintering method (for example, Patent Document 2) and an infiltration method (for example, Patent Document 3).

In the sintering method, an electrode material is manufactured through: a provisional sintering step of heating a mixing power of plural high melting point metals (such as Mo and Cr) at temperatures not lower than the melting point of Cu; a mixing step of pulverizing a reaction product (for example, a provisional sintered body of a MoCr alloy composition) obtained by the provisional sintering step and then mixing it with a Cu powder; and a sintering step of press molding a mixture powder obtained by the mixing step to produce a molded body and then heating the molded body in a non-oxidizing atmosphere at temperatures not higher than the melting point of Cu.

Meanwhile, in the infiltration method, an electrode material is manufactured through: a mixing step of mixing a Mo power and a Cr power uniformly; the molding step of press molding a mixed matter obtained by the mixing step; a provisional sintering step of sintering the molded body obtained by the molding step, at temperatures between 1100 and 1200° C.; and a Cu infiltration step of disposing a thin Cu plate on the provisional sintered body obtained by the provisional sintering step while keeping the temperature at 1100 to 1200° C., thereby inducing liquid-phase sintering of Cu and its infiltration into the provisional sintered body. The infiltration method is employed for the production of an electrode material for a vacuum interrupter requiring high voltage, high capacity and high frequency current-interrupting cap ability.

However, the sintering method has a fear of becoming high in cost of producing an electrode material, because it necessitates time to conduct the provisional sintering step and in the case of pulverizing the provisional sintered body it performs pulverization and classification in the environment where pulverization atmosphere is controlled.

Moreover, the infiltration method has a fear of becoming high in electrode material production cost since it performs the provisional sintering step, the Cu infiltration step and the like.

In the case of producing an electrode contact from an electrode material containing Cu as the primary component while containing one kind of high melting point metals, a Cu powder and a high melting point metal power (e.g. a Cr powder) are mixed and press-sintered thereby producing an electrode material. However, in the case of Patent Document 3 where an electrode contact is produced from an electrode material containing Cu as the primary component while containing two or more kinds of high melting point metals, the electrode material is not usable as an electrode contact if it is produced by simply mixing and press sintering the high melting point metal power because there exist a lot of pores in the interior of the electrode material.

The reason why the electrode material has a lot of pore spaces in its interior is probably because the diffusion of Cr into Mo occurs by sintering to reduce the size of Cr particles and the thus reduced amount behaves as pore spaces and because the pore spaces in the press-molded body are not charged with Cu due to the contraction associated with the sintering. An electrode contact made by the electrode material having a pore space in its interior carries the risk of poor brazing between the electrode contact and the electrode rod from the reasons such as the brazing material entering into the electrode contact.

Thus, a technique of adding a high melting point metal having excellent voltage resistance in order to improve the electrical characteristics such as voltage resistance of the electrode materials has been proposed; however, the thus produced electrode material sometimes cannot applied to products e.g. a vacuum breaker for reasons of the increase of the manufacturing cost or the like, and such a case is not rare. In view of the above, there is required an electrode material which can be manufactured at relatively low cost and excellent in electrical characteristics such as voltage resistance.

### REFERENCES ABOUT PRIOR ART

### Patent Documents

Patent Document 1; Japanese Patent Application Publication No. S59-27418

Patent Document 2: Japanese Patent Application Publication No. H04-334832

Patent Document 3; Japanese Patent Application Publication No. 2012-7203

Patent Document 4: Japanese Patent Application Publication No. 2002-373537

Patent Document 5: Japanese Patent Application Publication No. 2002-180150

### SUMMARY OF THE INVENTION

In view of the above, an object of the present invention is to provide a technique contributing to improvements of an electrode material in withstand voltage capability.

An aspect of an electrode material according to the present invention which can attain the above-mentioned object resides in an electrode material obtained by press molding a mixed substance and then sintering it, the mixed substance comprising: 10-50% by weight of a Cr powder wherein the volume-based relative particle amount of particles having particle diameters of 40 μm or less is less than 10%; 1-10% by weight of a refractory metal powder; and the balance Cu powder with inevitable impurities.

Additionally, another aspect of an electrode material according to the present invention which can attain the above-mentioned object resides in an electrode material wherein, in the above-mentioned electrode material, the refractory metal powder is at least one kind selected from any of Mo, W, Nb, Ta, V, Zr, Be, Hf, Ir, Pt, Ti, Si, Rh and Ru.

Additionally, a further aspect of an electrode material according to the present invention which can attain the above-mentioned object resides in an electrode material wherein, in the above-mentioned electrode material, the refractory metal powder has a particle diameter of 30 μm or less.

Additionally, a still further aspect of an electrode material according to the present invention which can attain the above-mentioned object resides in an electrode material wherein, in the above-mentioned electrode material, the Cr powder has an average particle diameter of 150 μm or less.

Additionally, an aspect of a method for producing an electrode material according to the present invention which can attain the above-mentioned object resides in a method for producing an electrode material which method comprises: a mixing step of mixing 10-50% by weight of a Cr powder wherein the volume-based relative particle amount of particles having particle diameters of 40 μm or less is less than 10%, 1-10% by weight of a refractory metal powder, and the balance Cu powder; a molding step of press molding the mixed substance obtained by the mixing step; and a sintering step of sintering the molded body obtained by the molding step.

Additionally, an aspect of a vacuum interrupter according to the present invention which can attain the above-mentioned object resides in a vacuum interrupter comprising: a fixed electrode; a movable electrode disposed opposed to and separable from the fixed electrode; and a vacuum vessel housing these electrodes, wherein at least one of the fixed electrode and the movable electrode is produced by press molding a mixed substance and then sintering it, the mixed substance comprising 10-50% by weight of a Cr powder wherein the volume-based relative particle amount of particles having particle diameters of 40 μm or less is less than 10%, 1-10% by weight of a refractory metal powder, and the balance Cu powder with inevitable impurities.

### BRIEF DESCRIPTION OF THE DRAWINGS

FIG. 1 A schematic cross-sectional view of an embodiment of a vacuum interrupter according to the present invention.

FIG. 2 A test result of particle diameter distribution of a Cr powder (A).

FIG. 3 A test result of particle diameter distribution of a Cr powder (B).

FIG. 4 (a) A photomicrograph of a cross section of an electrode material according to a conventional technique. (b) A photomicrograph of a cross section of an electrode material of Example 3.

FIG. 5 A characteristic diagram showing a relationship between a filling ratio of an electrode material and a Mo content.

FIG. 6 A characteristic diagram showing a relationship between the withstand voltage capability of an electrode material and the Mo content.

### MODE(S) FOR CARRYING OUT THE INVENTION

Referring now to the accompanying drawings, an embodiment of an electrode material, a method for producing the electrode material and a vacuum interrupter according to the present invention will be discussed in detail.

The present inventors studied improvements of withstand voltage capability from an optimum sintering temperature and from the mixing ratio among Cu, Cr and Mo while taking the particle size of Cu and the diffusion of Cu caused by sintering into account, thereby attaining the present invention.

In an embodiment of an electrode material and a method for producing the electrode material according to the present invention, a mixed powder obtained by mixing a Cu powder, a Cr powder and a refractory metal powder is press molded, and then the thus obtained press molded body is sintered in a non-oxidizing atmosphere at a temperature not higher than the melting point of Cu, thereby producing an electrode material at relatively low cost with good withstand voltage capability.

More specifically, a Cr powder wherein the volume-based relative particle amount of particles having particle diameters of 40 μm or less is less than 10% is used as a Cr powder to be mixed with the mixed powder, with which it becomes possible to produce an electrode material having a substantial filling ratio of 90% or more after sintering while including a tissue where solid solutions of Cr and a refractory metal is dispersed in a Cu phase.

As the Cu powder, a commercially available electrolytic copper powder is employed, for example. The shape of the Cu powder is not necessarily required to be dendrite, and therefore it may be spherical like an atomized powder and it may be irregular.

As the Cr powder, a powder having an average particle diameter of 150 μm or less (wherein the volume-based relative particle amount of particles having particle diameters of 40 μm or less is less than 10%) is employed, for example. The Cr powder is mixed with the mixed powder within a range of not smaller than 10 wt % and not larger than 50 wt %, more preferably within a range of not smaller than 20 wt % and not larger than 30 wt %, with which it becomes possible to produce an electrode material with good withstand voltage capability. An electrode material where the mixed amount of the Cr powder is within a range of not smaller than 20 wt % and not larger than 30 wt % can behave as an electrode material best for a vacuum interrupter (VI) the rated voltage of which is 12-36 kV, for example.

As a Mo powder, it is preferable to use a Mo powder having a particle diameter of 30 μm or less, more preferably a Mo powder having a particle diameter of less than 4 μm at the maximum. The Mo powder is mixed with the mixed powder within a range of not smaller than 1 wt % and not larger than 10 wt %, more preferably within a range of not smaller than 5 wt % and not larger than 7 wt %, with which it becomes possible to produce an electrode material with good withstand voltage capability. Though in Examples the refractory metal is exemplified by Mo, the effects equal thereto can be obtained even if a metal having refractoriness and a property of fining Cr particles (or a property which may become a factor for imparting pore spaces to an electrical material), like Mo, is used instead of the Mo powder. As the refractory metals, it is possible to cite tungsten (W), niobium (Nb), tantalum (Ta), vanadium (V), zirconium (Zr), beryllium (Be), hafnium (Hf), iridium (Ir), platinum (Pt), titanium (Ti), silicon (Si), rhodium (Rh), ruthenium (Ru) and the like.

The mixed powder is subjected to molding at molding pressures generally used in sintering (for example, 1-4 t/cm²) thereby gaining a molded body. The molded body is sintered in a non-oxidizing atmosphere (for example, in a hydrogen atmosphere or in a vacuum atmosphere) at a temperature of not higher than the melting point of Cu (1083° C.), thereby obtaining a sintered body. Incidentally, the particle diameter of the Mo powder is a value measured according to Fischer method while the average particle diameter of the Cr powder is a value measured by a laser diffraction particle size analyzer. Additionally, the case where the upper limit of particle of powder is specified means that the powder has been classified by sieving.

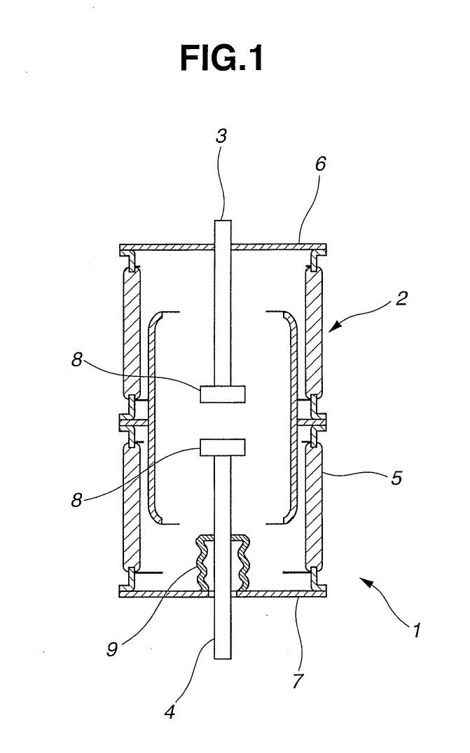

By using an electrode material according to an embodiment of the present invention, it is possible to construct a vacuum interrupter. As shown in FIG. 1, a vacuum interrupter 1 according to an embodiment of the present invention is provided to have a vacuum vessel 2, a fixed electrode 3 and a movable electrode 4.

The vacuum vessel 2 is configured such that an insulating cylinder 5 is sealed at its both opening ends with a fixed-side end plate 6 and a movable-side end plate 7, respectively.

The fixed electrode 3 is fixed in a state of penetrating the fixed-side end plate 6. The fixed electrode is fixed in such a manner that its one end is opposed to one end of the movable electrode 4 in the vacuum vessel 2, and additionally, provided with an electrode material 8 (i.e. an electrode contact) at an end portion opposing to the movable electrode 4.

The movable electrode 4 is provided at the movable-side end plate 7. The movable electrode 4 is disposed coaxial with the fixed electrode 3. The movable electrode 4 is moved in the axial direction by a not-illustrated opening/closing means, with which an opening/closing action between the fixed electrode 3 and the movable electrode 4 is attained. The movable electrode 4 is provided with an electrode material 8 at an end portion opposing to the fixed electrode 3. Between the movable electrode 4 and the movable-side end plate 7 a bellows 9 is disposed, so that the movable electrode 4 can vertically be moved to attain the opening/closing action between the fixed electrode 3 and the movable electrode 4 while keeping the vacuum state of the vacuum vessel 2.

Hereinafter, an electrode material and a method for producing the electrode material according to the present invention will be discussed in detail with reference to concrete examples. However, the present invention is not limited to these examples. In the method for producing the electrode materials of Examples and Comparative Examples, a common Cu powder and a common Mo powder (having an average particle diameter of 3 μm) were used.

### Comparative Example 1

A method for producing an electrode material of Comparative Example 1 is a Cu—Cr based electrode material which has conventionally been produced as an electrode material. The Cr particle diameter, the composition, the molding pressure, the sintering temperature and the sintering time thereof have been modified by manufacturers according to the desired characteristics.

A Cu powder and a Cr powder having an average particle diameter of 80 μm (hereinafter, referred to as a Cr powder (A)) were mixed to have a composition of Cu:Cr=80:20 by weight. A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1070° C. for two hours, thereby obtaining a sintered body (or an electrode material) of Comparative Example 1.

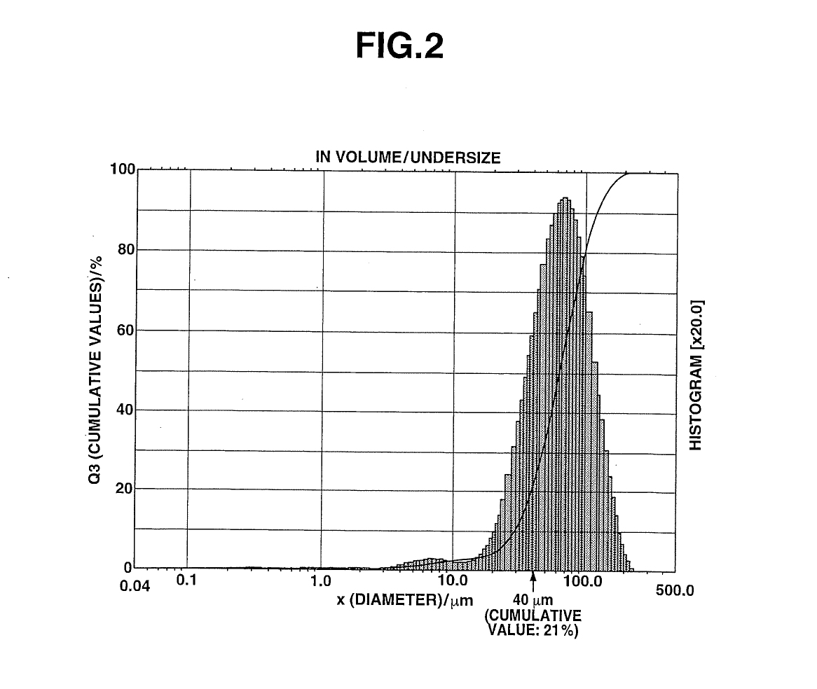

FIG. 2 is a diagram showing results of measuring the particle diameter distribution of the Cr powder (A) used in Comparative Example 1. In the Cr powder (A), the volume-based relative particle amount of particles having particle diameters of 40 μm or less was 21% (at a cumulative value).

### Example 1

A Cu powder, a Cr powder having an average particle diameter of 80 μm (hereinafter, referred to as a Cr powder (B)) and a Mo powder were mixed to have a composition of Cu:Cr:Mo=79:20:1 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1070° C. for two hours, thereby obtaining a sintered body (or an electrode material) of Example 1.

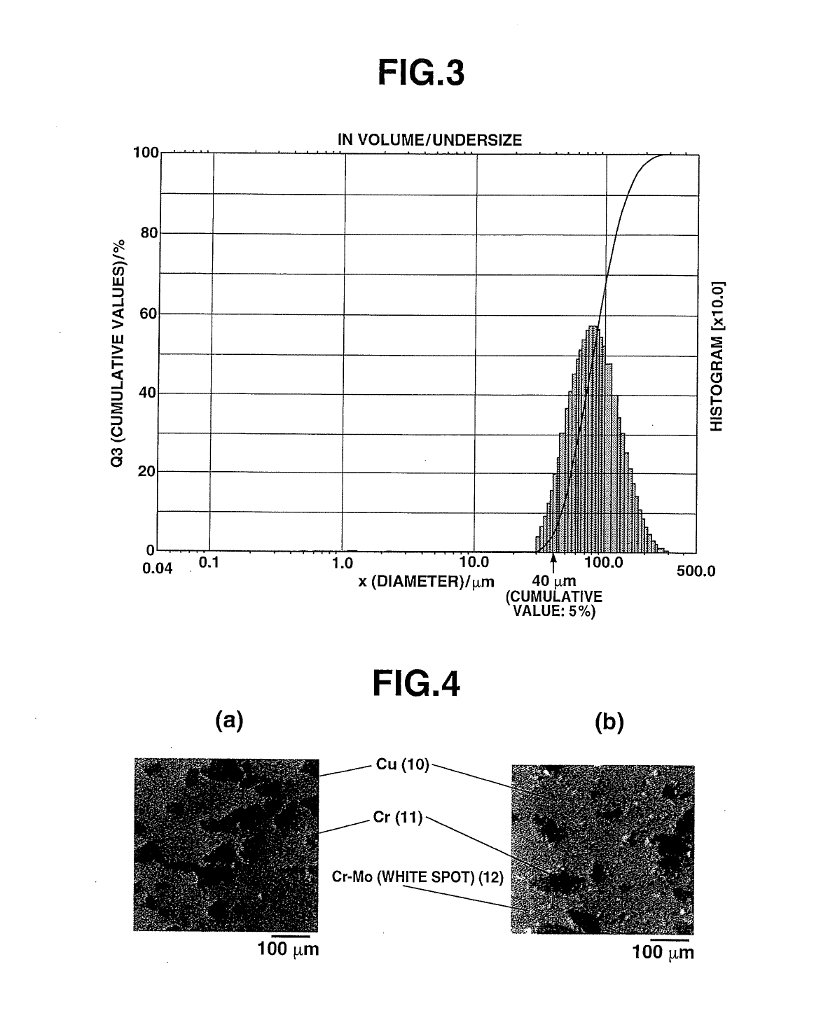

FIG. 3 is a diagram showing results of measuring the particle diameter distribution of the Cr powder (B) used in Example 1. The Cr powder (B) was obtained by sieving the Cr powder (A) so that its volume-based relative particle amount of particles having particle diameters of 40 μm or less was smaller than 5%.

### Example 2

A Cu powder, a Cr powder (B) and a Mo powder were mixed to have a composition of Cu:Cr:Mo=78:19:3 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1070° C. for two hours, thereby obtaining a sintered body (or an electrode material) of Example 2.

### Comparative Example 2

A Cu powder, a Cr powder (A) and a Mo powder were mixed to have a composition of Cu:Cr:Mo=79:20:1 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1045° C. for two hours, thereby obtaining a sintered body (or an electrode material) of Comparative Example 2.

### Comparative Example 3

A Cu powder, a Cr powder (A) and a Mo powder were mixed to have a composition of Cu:Cr:Mo=78:19:3 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1045° C. for two hours, thereby obtaining a sintered body (or an electrode material) of Comparative Example 3.

### Comparative Example 4

A Cu powder, a Cr powder (A) and a Mo powder were mixed to have a composition of Cu:Cr:Mo=76:19:5 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1045° C. for two hours, thereby obtaining a sintered body (or an electrode material) of Comparative Example 4.

### Comparative Example 5

A Cu powder, a Cr powder (A) and a Mo powder were mixed to have a composition of Cu:Cr:Mo=73:18:9 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1045° C. for two hours, thereby obtaining a sintered body (or an electrode material) of Comparative Example 5.

### Example 3

A Cu powder, a Cr powder (B) and a Mo powder were mixed to have a composition of Cu:Cr:Mo=76:19:5 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1045° C. for two hours, thereby obtaining a sintered body (or an electrode material) of Example 3.

### Example 4

A Cu powder, a Cr powder (B) and a Mo powder were mixed to have a composition of Cu:Cr:Mo=74:19:7 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1045° C. for two hours, thereby obtaining a sintered body (or an electrode material) of Example 4.

### Example 5

A Cu powder, a Cr powder (B) and a Mo powder were mixed to have a composition of Cu:Cr:Mo=76:19:5 by weight (wt %). A die having an inner diameter of 50 mm was charged with this mixed powder in an amount of 80 g, followed by molding the mixed powder at a pressure of 4 t/cm². The thus obtained molded body was sintered in a non-oxidizing atmosphere (i.e. a vacuum atmosphere of 5×10⁻⁵ Torr) at 1030° C. for two hours, thereby obtaining a sintered body (or an electrode material) of Example 5.

### Comparative Example 6

A Cu powder, a Cr powder of 100 mesh (mesh opening of 150 μm) and a Mo powder were mixed to have a composition of Cu:Cr:Mo=80:5:15 by weight (wt %). A die having an inner diameter of 50 mm was charged with this mixed powder in an amount of 80 g, followed by press molding the mixed powder at a pressure of 2 t/cm². The filling ratio of the molded body was 64%. The thus obtained molded body was sintered in a non-oxidizing atmosphere (i.e. a vacuum atmosphere of 5×10⁻⁵ Torr) at 1050° C. for two hours, thereby obtaining a sintered body (or an electrode material) of Comparative Example 6. The filling ratio of the sintered body of Comparative Example 6 was 73%. This is probably because a shrinkage caused by sintering was not so much and therefore the electrode material has a lot of pores in its interior.

[Evaluations on Characteristics of Electrode Material]

First of all, the sintered body of Comparative Example 1 and that of the sintered body of Example 3 were observed in cross section by a microscope (a backscattered electron image).

As shown in FIG. 4(a), the sintered body of Comparative Example 1 had a composition distribution where Cr particles 11 were dispersed in a Cu phase 10. On the other hand, as shown in FIG. 4(b), the sintered body of Example 3 was confirmed to have a tissue where Cr particles 11 were dispersed in a Cu phase 10 while Mo—Cr solid solutions 12 were uniformly dispersed in the Cu phase 10.

On the sintered bodies of Examples 1-5 and Comparative Examples 1-6, measurements of the filling ratio (%), the brazing property and the withstand voltage capability were conducted. The density of the sintered body was measured, upon which the filling ratio was calculated from (actual density/theoretical density)×100(%). In terms of the brazing property, a brazing material is placed between the sintered body and the Cu electrode rod, and then vacuum brazing is performed thereon, and then a simple hammer impact method or a tensile test between the sintered body and the Cu electrode rod is carried out, thereby evaluating the adhesion. In regard to the withstand voltage capability, a vacuum interrupter was assembled by using the sintered body as an electrode material and then a lightning-impulse flashover voltage test was conducted thereby obtaining a 50% flashover voltage (a lifting method). Incidentally, the withstand voltage capability is indicated by a value relative to that of the sintered body of Comparative Example 1. The test results of the sintered bodies are shown in Table 1.

TABLE 1

| | | | | | | Results of | | |
|---|---|---|---|---|---|---|---|---|
| | | | | | | performance test | | |
| | | | | | | | Withstand | |
| | | | | | Filling ratio | | voltage | |
| | Composition | | | Sintering | of sintered | | capability | |
| | (wt %) | | | temperature | body | Brazing | (Relative | |
| | Cr | Mo | Cr powder | (° C.) | (%) | property | value) | Conclusion |
| Comparative | 20 | 0 | Powder (A) | 1070 | 94 | ◯ | 1.00 | ◯ |
| Example 1 | | | | | | | | |
| Example 1 | 20 | 1 | Powder (B) | 1070 | 91 | ◯ | 1.03 | ◯ |
| Example 2 | 19 | 3 | Powder (B) | 1070 | 89 | Δ | 1.07 | ◯ |
| Comparative | 20 | 1 | Powder (A) | 1045 | 89 | X | | X |
| Example 2 | | | | | | | | |
| Comparative | 19 | 3 | Powder (A) | 1045 | 87 | X | | X |
| Example 3 | | | | | | | | |
| Comparative | 19 | 5 | Powder (A) | 1045 | 85 | X | | X |
| Example 4 | | | | | | | | |
| Comparative | 18 | 9 | Powder (A) | 1045 | 83 | X | | X |
| Example 5 | | | | | | | | |
| Example 3 | 19 | 5 | Powder (B) | 1045 | 92 | ◯ | 1.27 | ⊚ |
| Example 4 | 19 | 7 | Powder (B) | 1045 | 90 | ◯ | 1.31 | ⊚ |
| Example 5 | 19 | 5 | Powder (B) | 1030 | 90 | ◯ | 1.20 | ⊚ |
| Comparative | 5 | 15 | 100mesh | 1050 | 73 | X | | X |
| Example 6 | | | | | | | | |

As apparent from Table 1, the sintered bodies of Examples 1 to 5 where the Cr powder (B) was used had excellent brazing property and improved in withstand voltage capability as compared with the sintered body of Comparative Example 1.

From results of Table 1, it can be found that there is a correlation between the brazing property and the filling ratio of the sintered body and that the brazing property is enhanced by improving the filling ratio of the sintered body. More specifically, it is considered that 90% or more filling ratio makes the brazing property stable.

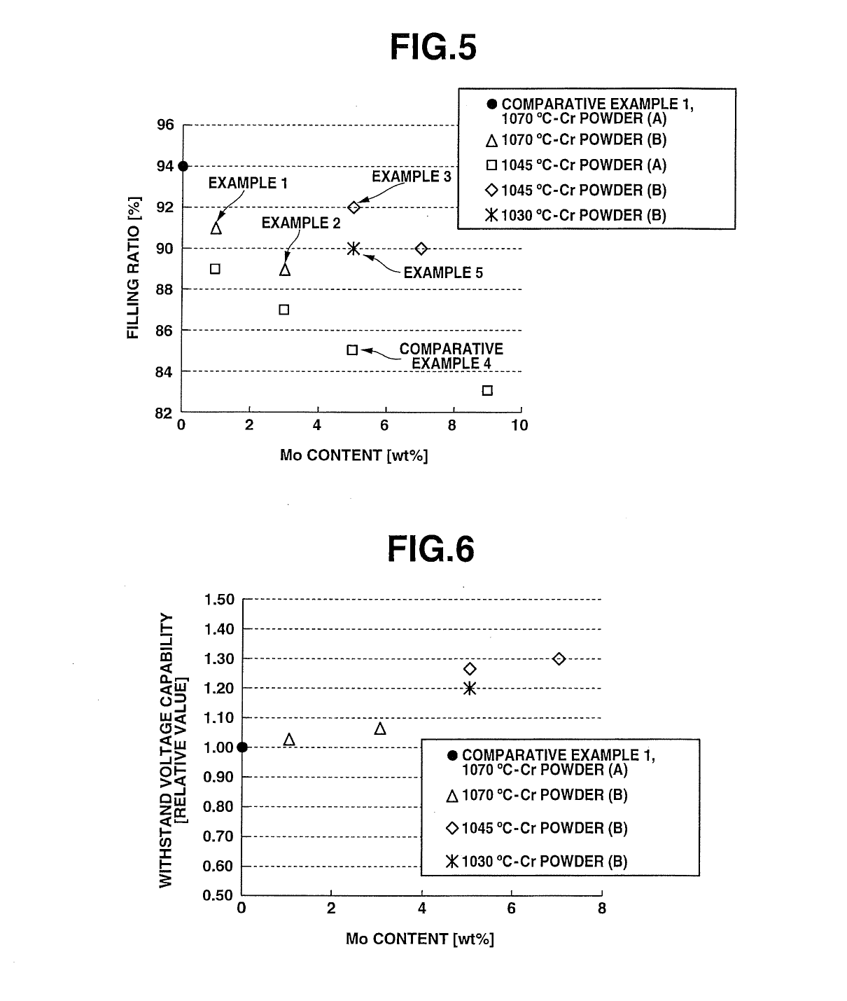

FIG. 5 is a diagram showing a relationship between the filling ratio of the sintered body and the Mo content. Additionally, FIG. 6 is a diagram showing a relationship between the withstand voltage capability of the sintered body and the Mo content. As apparent from FIG. 5, the filling ratio of the sintered body can be confirmed to decrease according to the Mo content. Meanwhile, as shown in FIG. 6, the withstand voltage capability can be confirmed to increase according to the Mo content.

Namely, in order to enhance the withstand voltage capability of the electrode material it is necessary to increase the Mo content, but when the Mo content is increased, the electrode material is reduced in filling ratio and brazing property so as to become difficult to be used as an electrode material.

Comparing the electrode material of Example 5 with the electrode material of Comparative Example 4 as shown in FIG. 5, it is clear that even if their Mo contents are equal the filling ratio of the sintered body is improved by adjusting the volume-based relative particle amount of fine Cr particles having particle diameters of 40 μM or less to less than 5%. This is probably because, by adjusting the particle amount of Cr particles having particle diameters of 40 μm or less (such Cr particles are considered to be able to easily disperse in Mo) to less than 10% (more preferably less than 5%), the dispersing amount of Cr at the time of sintering is restrained to lessen the pore spaces in the sintered body thereby improving the filling ratio of the sintered body.

More specifically, the filling ratio of the sintered body is improved by adjusting the particle diameter distribution of the Cr powder to be mixed with the Mo powder. As a result, the Mo content in the sintered body can be increased and additionally it becomes possible to enhance the withstand voltage capability of the sintered body.

If comparisons are made between Examples 3 and 5 as shown in FIG. 5, it can be found that the filling ratio of the sintered body is changed according to the sintering temperature. As a result of FIG. 5, a sintering temperature of 1045° C. makes the filling ratio highest while a case where the sintering temperature is smaller than 1045° C. lowers the filling ratio. Moreover, an electrode material having a filling ratio exceeding 90% though its sintering temperature is high is small in Mo content and therefore a dramatic improvement of the withstand voltage capability cannot be expected. In view of the above, a sintered body excellent in both filling ratio and brazing property can be obtained by adjusting the sintering temperature to 980-1080° C., more preferably to 1070-1030° C., much more preferably to 1045° C.

Then, the electrode material of Example 5 was disposed respectively at an end portion of a fixed electrode and that of a movable electrode as an electrode contact, upon which a weldability test was conducted. In the weldability test, the both electrodes were welded according to STC test (25 kA-3s), and the weldability was evaluated based on a force (kN) necessary to peel these electrodes away from each other. Results of the weldability test were shown in Table 2. As a result of the STC test, the weldability of the electrode material of Example 5 was evaluated as good.

TABLE 2
Result of weldability test (STC test: 25 kA-3 s)

| Test Item | Welded area [mm²] | Welding force [kN] |
|---|---|---|
| Example 5 | 26.9 | 4.8 |
| Example 5 | 32.7 | 6.3 |

In an electrode material according to an embodiment of the present invention as discussed above, a Cu powder, a Cr powder and a refractory metal powder are mixed and the thus obtained mixed powder was press molded and then sintered. In this electrode material a Cr powder wherein the volume-based relative particle amount of particles having particle diameters of 40 μm or less is less than 10% is mixed in the mixed powder. With this, it becomes possible to obtain an electrode material excellent in both brazing property and withstand voltage capability.

Additionally, in the method for producing the electrode material according to an embodiment of the present invention, a Cr powder which has previously been adjusted in terms of particle diameter distribution is mixed in the mixed powder and this mixed power is press molded and the molded body is subjected to sintering at a temperature not higher than the melting point of Cu. With this, it becomes possible to manufacture an electrode material which is high in filling ratio after sintering and brazing-possible, at relatively low cost.

Furthermore, according to the electrode material and the method for producing the electrode material of the present invention, it is possible to obtain an electrode material having a substantial filling ratio of 90% or more after sintering while including a tissue where solid solutions of Cr and a refractory metal are dispersed in a Cu phase.

Furthermore, according to the method for producing the electrode material of the present invention, it is possible to manufacture an electrode material which is dense and excellent in withstand voltage capability since solid solutions of high melting point metals (such as Cr and Mo) are uniformly dispersed in the Cu phase.

If an electrode material of the present invention is disposed at least at one of a fixed electrode and a movable electrode of a vacuum interrupter (VI), the withstand voltage capability of an electrode contact of the vacuum interrupter is to be improved. When the withstand voltage capability of the electrode contact is improved, a gap caused at the time of opening/closing between a movable-side electrode and a fixed-side electrode can be shortened as compared with that of conventional vacuum interrupters and additionally a gap between the electrodes and the insulating cylinder can be shortened; therefore, it is possible to minify the structure of the vacuum interrupter. As a result, a vacuum circuit breaker including the vacuum interrupter as a component can be downsized. For example, in the case of an alternating current circuit breaker usually comprising three vacuum interrupters, the downsizing per one vacuum interrupter makes the vacuum circuit breaker very compact. Thus, it is possible to reduce the size of the components of the vacuum circuit breaker, and it is possible to reduce the manufacturing cost of the vacuum interrupter.

1.-4. (canceled)

5. A method for producing an electrode material, comprising:
a mixing step of mixing 10-50% by weight of a Cr powder wherein the volume-based relative particle amount of particles having particle diameters of 40 μm or less is less than 10%, 1-10% by weight of a refractory metal powder having a particle diameter of 30 μm or less, and the balance Cu powder;
a molding step of press molding the mixed substance obtained by the mixing step; and
a sintering step of sintering the molded body obtained by the molding step.

6. (canceled)
